(19) United States
(12) Patent Application Publication
(10) Pub. No.: US 2011/0148980 A1
(43) Pub. Date: Jun. 23, 2011

(54) OIL INKJET PRINTING METHOD AND INK SET

(75) Inventors: Sayako ARAI, Tokyo (JP); Ami NAKATA, Tokyo (JP)

(73) Assignee: RISO KAGAKU CORPORATION, Tokyo (JP)

(21) Appl. No.: 12/968,650

(22) Filed: Dec. 15, 2010

(30) Foreign Application Priority Data
Dec. 18, 2009 (JP) JP2009-288181
Dec. 18, 2009 (JP) JP2009-288182
Apr. 5, 2010 (JP) JP2010-87206

(51) Int. Cl. B41J 2/015; C08K 7/00

(52) U.S. Cl. 347/21; 524/557; 524/493; 524/425

(57) ABSTRACT

Pre-treatment solutions are provided, which can improve printing density and prevent bleeding and strike through when printing, particularly inkjet printing is performed with an oil ink on a printing medium that has been treated with the pre-treatment solutions. The pre-treatment-solution can be selected from the following (I), (II) and (III):
(I): a pre-treatment solution which comprises at least inorganic particles with an average particle diameter of not less than 1 μm and not more than 20 μm and a solvent, in which the difference in solubility parameter (SP value) between the solvent of the pre-treatment solution and the solvent of the oil ink is not less than 1.0 (cal/cm³)^{1/2};
(II): a pre-treatment solution which comprises at least inorganic particles with an average particle diameter of not less than 0.1 μm and less than 1 μm and a solvent, in which the difference in solubility parameter (SP value) between the solvent of the pre-treatment solution and the solvent of the oil ink is not less than 2.0 (cal/cm³)^{1/2}; and
(III): a pre-treatment solution which comprises at least inorganic particles, a polyvinyl alcohol with a degree of polymerization of not more than 500 and a degree of saponification of not less than 60 mol %, and water.

### BACKGROUND OF THE INVENTION

1. Field of the Invention

The present invention relates to an oil inkjet printing method which can improve printing density by inhibiting ink permeation into printing media so as to prevent strike through and bleeding and preferably can further improve drying of ink, and also relates to an ink set and a pre-treatment solution used for the printing method.

2. Description of Related Art Including Information Disclosed Under 37 CFR 1.97 and 1.98

In the inkjet printing system, recently, it is further demanded that full color printing can be performed without any restriction of a recording medium in higher speed. The use of the line head inkjet printing system is suitable for responding to this demand. In this case, ink is required to be rapid in permeation into plain paper and drying and capable of providing a high-quality printed image which is high in printing density and low in bleeding and strike through.

Inkjet ink used for the inkjet printing system is generally classified into aqueous ink and non-aqueous ink.

The aqueous ink comprises water as a solvent and thus easily provides printed images high in density and quality when plain paper is used as a printing medium, because the solvent easily permeates into the printing medium so that pigments are easily kept on the surface of the printing medium. On the other hand, the aqueous ink is disadvantageous in that it easily causes the printing medium to generate curl and cockling, thereby affecting conveyance of the printing medium and producing a bad effect on high-speed printing.

The non-aqueous inks is generally classified into solvent ink composed mainly of a very-volatile organic compound as a solvent and oil ink composed mainly of a low-volatile organic compound as a solvent. The solvent ink is excellent in drying, but operating environment is limited because a large amount of solvents are volatilized. On the other hand, the oil ink is advantageous in that ink stain hardly occurs inside printing devices or on continuously printed printing paper because coloring materials and solvents easily permeate together into printing paper so that coloring materials hardly remain on the surface of printing paper. Also, the oil ink is advantageous in that water resistance is better than the aqueous ink. Moreover, the oil ink is advantageous in that when plain paper is used as a printing medium, not only permeability into the printing medium and drying are excellent, but also the solvent is difficult to volatilize compared with the aqueous ink and the solvent ink, and thus clogging in ink nozzles is unlikely to occur, thereby reducing frequency of cleaning of ink nozzles. Thus, the oil ink is suitable for high-speed printing, particularly high-speed inkjet printing using a line head printer.

However, the oil ink is defective in that it is poor in separation of the coloring material from the solvent on the printing medium, and particularly when plain paper is used as a printing medium, both the coloring material and the solvent easily permeate into a gap between fibers of the printing medium, thereby causing deterioration of quality of printed images due to decrease of printing density, increase of strike through and bleeding of printed dots.

Conventionally, there exists a variety of special paper provided with an ink receiving layer constituted by inorganic particles and a fixing resin so as to keep the coloring material on the surface of the paper. However, in order to obtain a similar effect on plain paper, a mean for keeping the coloring material on the surface of the paper during printing is required. As a method for keeping a coloring material and a solvent together on a surface of plain paper without permeation, it has been already proposed for an aqueous ink that a reactive substance is contained in an ink whilst a treatment solution is provided which contains a substance reactive with the above substance, and the treatment solution is ejected onto the ink, whereby both substances are reacted on the surface of paper to cause aggregation of coloring materials, thereby making it difficult for the coloring materials to permeate into the paper (Patent Documents 1 and 2). Also, it has been proposed that a pre-treatment solution containing cationic inorganic particles is reacted with an aqueous ink containing an anionic dye to cause fixation (Patent Document 3). However, no method exhibiting a similar effect has been proposed for the non-aqueous ink.

In addition, when plain paper is treated with a pre-treatment solution containing inorganic particles, it is preferable to use water which is good in drying and safe as a solvent for the pre-treatment solution, but a large amount of water in the pre-treatment solution causes deformation of the plain paper and gives a bad influence on conveyance of printing media, which turns out to be an inhibiting factor for high-speed printing.

In the high-speed line head inkjet printing system, formation of a sharp image at a low resolution is required, and for this purpose, ink dots are required to be of a perfect circle with a high printing density. Further, it is required that the ink is rapidly absorbed into printing paper immediately after printed so that no ink stain occurs inside printing devices or on continuously printed printing paper in a post-processing step by a finisher device or the like.

As a method for improving quality of printed image in the inkjet printing using an oil ink, it has been proposed that printing is performed on an ink receiving layer that is made of a polymer comprising, as a monomer unit, a compound having an aliphatic hydrocarbon group with 8-18 carbon atoms such as alkyl(meth)acrylates, alkylaryl(meth)acrylates, alkyl(meth)acrylamides, alkylaryl(meth)acrylamides, alkylstyrenes and α-olefins (Patent Document 4). This ink receiving layer has an effect of improving image density, ink absorption and image unevenness, but has no effect of inhibiting ink stain on rollers inside printing devices or on continuously printed printing paper.

In addition, as another method, it has been proposed that an ink is printed on an ink receiving layer which comprises not less than 50 weight % of silica having a predetermined average particle diameter, specific surface area and oil absorption (Patent Document 5). This ink receiving layer has an effect of increasing the diameter of printed dots and thereby providing high printing density, but has no effect of inhibiting ink stain on rollers inside printing devices or on continuously printed printing paper.
Patent Document 1: JP-A-H08-281930
Patent Document 2: JP-A-2000-198263
Patent Document 3: JP-A-2007-276387
Patent Document 4: JP-A-H11-286166
Patent Document 5: JP-A-2005-96167

### BRIEF SUMMARY OF THE INVENTION

The present invention aims at providing a novel pre-treatment solution which enhances printing density of prints and prevents bleeding and strike through in a printing system in which a pre-treatment solution is applied onto a printing medium, and then printing is performed on the printing medium with an oil ink containing a coloring material, for example, a printing system by an inkjet method, particularly an inkjet printing system in which printing is performed on plain paper using a line head inkjet printer.

Further, the present invention also aims at not only providing high printing density when printing is performed with the oil ink, particularly when printing is performed at a relatively low resolution such as 300×300 dpi with a high-speed line head inkjet printer, but also inhibiting ink stain on rollers inside printing devices or on continuously printed printing paper.

As a result of diligent researches under the above objects, the present inventors have found that the above objects can be achieved by using a specific pre-treatment solution, and thus have completed the present invention.

That is, according to one aspect of the present invention, there is provided a printing method using an oil ink, which comprises applying a pre-treatment solution onto a printing medium and then performing printing on the printing medium using an oil ink that comprises at least a coloring material and a solvent, in which said pre-treatment solution is selected from the pre-treatment solutions shown in the following (I), (II) and (III).

(I): A pre-treatment solution which comprises at least inorganic particles with an average particle diameter of not less than 1 μm and not more than 20 μm and a solvent, in which the difference in solubility parameter (SP value) between the solvent of the pre-treatment solution and the solvent of the oil ink is not less than 1.0 (cal/cm³)^{1/2}.

(II): A pre-treatment solution which comprises at least inorganic particles with an average particle diameter of not less than 0.1 μm and less than 1 μm and a solvent, in which the difference in solubility parameter (SP value) between the solvent of the pre-treatment solution and the solvent of the oil ink is not less than 2.0 (cal/cm³)^{1/2}.

(III) A pre-treatment solution which comprises at least inorganic particles, a polyvinyl alcohol with a degree of polymerization of not more than 500 and a degree of saponification of not less than 60 mol %, and water.

According to another aspect of the present invention, there is provided an ink set useful for applying a pre-treatment solution on a printing medium and then performing printing on the printing medium with an oil ink, which comprises an oil ink comprising at least a coloring material and a solvent, and a pre-treatment solution selected from the above-defined pre-treatment solutions (I), (II) and (III).

According to still another aspect of the present invention, there is provided a pre-treatment solution useful for printing with an oil ink by applying a pre-treatment solution on a printing medium and then performing printing on the printing medium with the oil ink, which is selected from the above-defined pre-treatment solutions (I), (II) and (III).

According to the present invention, a pre-treatment solution selected from the above pre-treatment solutions (I), (II) and (III) is used, and thus printing density is improved.

Particularly, when the above pre-treatment solution (I) or (II) is used as a pre-treatment solution, the surface of the printing medium is filled so as to prevent the printed oil ink or the coloring material contained in the ink from permeating into the printing medium and keep the coloring material to remain on the surface of the printing medium, and thus printing density is improved whilst strike through and bleeding are prevented.

In addition, when the above pre-treatment solution (III) is used as a pre-treatment solution, ink dots of a perfect circle can be obtained, and thus a sharp image high in printing density even at a low resolution can be obtained. Also, the above pre-treatment solution (III) contains a polyvinyl alcohol with a degree of polymerization of not more than 500 and a degree of saponification of not less than 60%, and thus ink stain on rollers inside printing devices and on continuously printed printing paper can be prevented.

### DETAILED DESCRIPTION OF THE INVENTION

Hereinafter, the present invention will be further described in detail.

### 1. Oil Inks

The oil ink used in the present invention is composed mainly of a solvent and a pigment, but may contain other components, if required.

### 1-1. Solvents

The solvent is not particularly limited as long as it functions as a medium of an ink, that is, a vehicle, and may be any of volatile or non-volatile solvents. However, in the present invention, the solvent is preferably composed mainly of a non-volatile solvent from the viewpoint of environment. The non-volatile solvent preferably has a boiling point of not less than 200° C. and more preferably not less than 240° C. The solvent preferably has a solubility parameter (SP value) of not less than 6.5 (cal/cm³)^{1/2} and not more than 10.0 (cal/cm³)^{1/2} and more preferably not less than 7.0 (cal/cm³)^{1/2} and not more than 9.0 (cal/cm³)^{1/2}.

Any of non-polar organic solvents and polar organic solvents may be used as a solvent. These solvents can be used alone or in combination of two or more on condition that they form a single phase. In the present invention, a non-polar organic solvent and a polar organic solvent are preferably used in combination, and a solvent is preferably composed of 20-80 mass % of a non-polar solvent and 80-20 mass % of a polar solvent, and more preferably 30-45 mass % of a non-polar solvent and 55-70 mass % of a polar solvent.

### 1-1-1. Non-Polar Solvents

As the non-polar organic solvent, petroleum based hydrocarbon solvents including naphthenic, paraffinic and isoparaffinic ones can be used. Concrete examples include dodecane and other aliphatic saturated hydrocarbons, “ISOPAR and EXXOL” (both trade names) available from ExxonMobil Corporation, “AF SOLVENTS, NORMAL PARAFFIN H” (both trade names) available from Nippon Oil Corporation, and “SUNSEN and SUNPAR” (both trade names) available from Japan Sun Oil., Ltd. These can be used alone or in combination of two or more.

### 1-1-2. Polar Solvents

As the polar solvent, ester solvents, alcohol solvents, fatty acid solvents and ether solvents can be used. These can be used alone or in combination of two or more.

The ester solvent includes, for example, higher fatty acid esters having 5 or more, preferably 9 or more and more preferably 12 to 32 carbon atoms in one molecule. Examples thereof include isodecyl isononanoate, isotridecyl isononanoate, isononyl isononanoate, methyl laurate, isopropyl laurate, isopropyl myristate, isopropyl palmitate, isooctyl palmitate, hexyl palmitate, isostearyl palmitate, isooctyl isopalmitate, methyl oleate, ethyl oleate, isopropyl oleate, butyl oleate, hexyl oleate, methyl linoleate, isobutyl linoleate, ethyl linoleate, butyl stearate, hexyl stearate, isooctyl stearate, isopropyl isostearate, 2-octyldodecyl pivalate, soybean oil methyl ester, soybean oil isobutyl ester, tall oil methyl ester, tall oil isobutyl ester, diisopropyl adipate, diisopropyl sebacate, diethyl sebacate, propylene glycol monocaprate, trimethylolpropane tri-2-ethylhexanoate, and glyceryl tri-2-ethylhexanoate.

The alcohol solvent includes, for example, aliphatic higher alcohols having 12 or more carbon atoms in one molecule. Concrete examples thereof include higher alcohols such as isomyristyl alcohol, isopalmityl alcohol, isostearyl alcohol, and oleyl alcohol.

The fatty acid solvent includes, for example, fatty acids having 4 or more, preferably 9 to 22 carbon atoms in one molecule. Examples thereof include isononanoic acid, isomyristic, acid, hexadecanoic acid, isopalmitic acid, oleic acid, and isostearic acid.

The ether solvent includes, for example, glycol ethers such as diethylglycol monobutyl ether, ethyleneglycol monobutyl ether, propyleneglycol monobutyl ether and propyleneglycol dibutyl ether, and acetates of glycol ethers.

### 1-2. Coloring Materials

As the coloring material, any of pigments and dyes can be used, and may be used alone or in combination of both. It is preferable to use a pigment as a coloring material from the viewpoint of weatherability and printing density of prints.

The coloring material is contained preferably in an amount of 0.01 to 20 mass % based on the total amount of the oil ink.

### 1-2-1. Dyes

As the dye, dyes generally used in the technical field of printing can be used without any particular limitation. Examples thereof include oil-soluble dyes such as naphthol dyes, azo dyes, metal complex salt dyes, anthraquinone dyes, quinone imine dyes, indigo dyes, cyanine dyes, quinoline dyes, nitro dyes, nitroso dyes, benzoquinone dyes, carbonium dyes, naphthoquinone dyes, naphthalimide dyes, phthalocyanine dyes and perinine dyes. These dyes can be used alone or in combination of two or more.

### 1-2-2. Pigments

As the pigment, pigments generally used in the technical field of printing, including organic and inorganic pigments, can be used without any particular limitation. Examples thereof which can preferably be used include carbon black, cadmium red, chromium yellow, cadmium yellow, chromium oxide, viridian, titanium cobalt green, ultramarine blue, Prussian blue, cobalt blue, azo pigments, phthalocyanine pigments, quinacridone pigments, isoindolinone pigments, dioxadine pigments, threne pigments, perylene pigments, thioindigo pigments, quinophthalone pigments and metal complex pigments. These pigments may be used alone or in combination of two or more.

### 1-2-3. Pigment Dispersing Agents

It is preferable to add a pigment dispersing agent to the oil ink in order to make good dispersion of the pigment in the oil ink. The pigment dispersing agents used in the present invention are not particularly limited as long as they can stably disperse the pigment in a solvent. Examples thereof include a hydroxyl group-containing carboxylic acid ester, a salt of a long-chain polyaminoamide and a high-molecular weight acidic ester, a salt of a high molecular weight polycarboxylic acid, a salt of a long-chain polyaminoamide and a polar acidic ester, a high molecular weight unsaturated acidic ester, a high molecular weight copolymer, a modified polyurethane, a modified polyacrylate, a polyetherester type anionic surfactant, a naphthalene sulfonic acid formalin condensate salt, a polyoxyethylene alkylphosphoric acid ester, a polyoxyethylene nonylphenyl ether, a polyesterpolyamine, a stearylamine acetate and the like. Of these, high molecular weight dispersing agents are preferably used.

Concrete examples of the pigment dispersing agents include “SOLSPERSE 5000 (phthalocyanine ammonium salt based), 13940 (polyester amine based), 17000, 18000 (aliphatic amine based), 11200, 22000, 24000, and 28000” (all trade names) available from Lubrizol Japan Ltd.; “EFKA 400, 401, 402, 403, 450, 451, 453 (modified polyacrylate), 46, 47, 48, 49, 4010, 4055 (modified polyurethane)” (all trade names) available from Efka Chemicals; “DEMOL P, EP, POIZ 520, 521, 530, HOMOGENOL L-18 (polycarboxylate type polymer surfactants)” (all trade names) available from Kao Corporation; “DISPARLON KS-860, KS-873N4 (high molecular weight polyester amine salt)” (both trade names) available from Kusumoto Chemicals, Ltd.; and “DISCOL 202, 206, OA-202, OA-600 (multi-chain polymeric nonionic based)” (all trade names) available from Daiichi Kogyo Seiyaku Co., Ltd.

Of the above pigment dispersing agents, a polyamide-based dispersing agent that has a pectinated structure constituted by a plurality of side chains composed of polyester is preferably used. The polyamide-based dispersing agent that has a pectinated structure constituted by a plurality of side chains composed of polyester is a compound which has a main chain containing many nitrogen atoms such as polyethylene-imine and has a plurality of side chains that are bonded to the nitrogen atoms through amide-linkage in which the side chains are polyesters. Examples thereof include dispersing agents with a structure that has a main chain formed of polyalkyleneimine such as polyethyleneimine to which 3 to 80 poly(carbonyl-C₃₋₆-alkyleneoxy) chains are bonded as side chains through amide-linkage, as is disclosed in JP-A-H5-177123. The above SOLSPERSE 11200 and SOLSPERSE 28000 (all trade names) available from Lubrizol Japan Ltd. correspond to the polyamide-based dispersing agent having such a pectinated structure.

The pigment dispersing agents may be contained in an amount sufficient to disperse the pigment in the above organic solvents, and the amount can be set properly.

### 1-3. Other Components

In addition to the above organic solvent, coloring material and pigment dispersing agent, other components such as surfactants, fixing agents and antiseptics can be added to the oil ink of the present invention as long as they do not adversely affect the property of the ink.

### 1-4. Production Method of the Oil Ink

The oil ink of the present invention can be prepared by putting the whole or part of the components in a known dispersing machine such as a beads mill to obtain a dispersion and if necessary passing it through a known filtering machine such as a membrane filter. For example, the oil ink can be prepared by previously mixing part of the solvent with the whole of the pigment uniformly and dispersing the mixture in a dispersing machine, and then adding the rest of the components to the resulting dispersion followed by filtration.

### 2. Pre-Treatment Solutions

### 2-1. Pre-Treatment Solutions (I) and (II)

The pre-treatment solutions (I) and (II) used in the present invention comprise at least inorganic particles and a solvent, and may contain other components, if required.

### 2-1-1. Inorganic Particles

As the inorganic particle, can be used an inorganic particle used as an extender pigment, and examples thereof include inorganic particles such as of silica, calcium carbonate, barium sulfate, titanium oxide, zinc oxide, alumina white, aluminum hydroxide, white clay, talc, clay, diatomite, kaolin and mica. These inorganic particles are required to have an average particle diameter of not less than 0.1 μm and not more than 20 μm, preferably not less than 0.1 μm and not more than 15 μm and more preferably not less than 0.1 μm and not more than 12 μm. In both cases where the average particle diameter is smaller than 0.1 μm and where the average particle diameter is larger than 20 μm, the effect of filling the printing medium is insufficient and the effect of improving printing density cannot be obtained sufficiently.

The inorganic particles are preferably contained in an amount of 0.01-40 mass %, more preferably 5-30 mass % relative to the total amount of the pre-treatment solution (I) or (II).

When the inorganic particles having an average particle diameter of not less than 1 μm and not more than 20 μm is used, those exhibiting a liquid absorbency (A) of 0.2-1.4 as calculated in accordance with the following equation (1) is preferably used, and those exhibiting a liquid absorbency (A) of 0.3-1.0 is more preferably used. When the liquid absorbency (A) of the inorganic particles is smaller than the above range, bleeding of printing dots is increased, and the effect of enhancing printing density and preventing strike through cannot be obtained sufficiently. When the liquid absorbency (A) of the inorganic particles is larger than the above range, bleeding of printed dots becomes too small, and when printing is performed at a resolution of 300×300 dpi or the like, a dot size sufficient for forming solid image cannot be obtained, and prints with high density cannot be obtained although strike through is inhibited. Also, when the liquid absorbency (A) is too large, the inorganic particles cannot be dispersed well in the pre-treatment solution, and the viscosity of the pre-treatment solution increases abruptly so that uniform coating is difficult to perform.

In addition, when the amount (g/m²) of the inorganic particles resulting from the application of the pre-treatment solution onto a printing medium is too much, bleeding of printed dots becomes too small, and when printing is performed at a resolution of 300×300 dpi or the like, a dot size sufficient for forming solid image cannot be obtained, and prints with high density cannot be obtained although strike through is inhibited. Therefore, the amount of the pre-treatment solution to be applied is preferably 0.3-2.5 g/m² and more preferably 0.5-2 g/m² as an amount of inorganic particles.

A=B/C (1)

wherein
A: liquid absorbency of inorganic particles;
B: oil absorption of inorganic particles (ml/100 g);
C: specific surface area of inorganic particles (m²/g).
B is determined by measurement of linseed oil absorption in accordance with JIS K-5101-21.
C is determined by BET specific surface area measurement method.

### 2-1-2. Solvents

The solvent of the pre-treatment solutions (I) and (II) used in the present invention can be selected from the group consisting of water and organic solvents. Water is not particularly limited as long as it does not adversely affect the property of the pre-treatment solution, and for example, may be tap water or ion exchanged water. The organic solvent may be any of water-soluble organic solvents and water-insoluble organic solvents as long as it has a solubility parameter in the predetermined range.

The water-soluble organic solvent includes, for example, glycol solvents, glycol ethers, acetates of glycol ethers, lower alcohols, glycerin, diglycerin, triglycerin, polyglycerins, imidazoridinone solvents, and 3-methyl-2,4-pentanediol. These can be used alone, or can be used in combination of two or more as long as they form a single phase.

The glycol solvent includes, for example, alkylene glycols such as ethylene glycol, diethylene glycol, triethylene glycol and propylene glycol.

The glycol ether includes alkylene glycol alkyl ethers and polyalkylene glycol alkyl ethers (both collectively referred to as (poly)alkylene glycol alkyl ethers in this specification), and concrete examples thereof include the compounds represented by the following chemical formula (1).

R¹—O(C₂H₄—O)ₙ—R² (1)

In formula (1), R¹ and R² each independently represent a hydrogen atom or an alkyl group having 1-6, preferably 4-6 carbon atoms, and n is an integer of 1 to 4.

Specific examples of (poly)alkylene glycol alkyl ethers represented by the above mentioned chemical formula (1) include, for example, ethylene glycol monobutyl ether, diethylene glycol monomethyl ether, diethylene glycol monoethyl ether, diethylene glycol monopropyl ether, diethylene glycol monobutyl ether, triethylene glycol monopropyl ether, triethylene glycol monobutyl ether, triethylene glycol monohexyl ether, tetraethylene glycol monomethyl ether, tetraethylene glycol monoethyl ether, tetraethylene glycol monopropyl ether, tetraethylene glycol monobutyl ether, diethylene glycol diethyl ether, diethylene glycol dibutyl ether, triethylene glycol diethyl ether and triethylene glycol dibutyl ether.

Another example of (poly)alkylene glycol alkyl ethers include the compounds represented by the following chemical formula (2).

R¹—O(C₃H₆—O)ₙ—R² (2)

In formula (2), R¹ and R² each independently represent a hydrogen atom or an alkyl group having 1-6, preferably 4-6 carbon atoms, and n is an integer of 1 to 4.

Specific examples of (poly)alkylene glycol alkyl ethers represented by the above mentioned formula (2) include, for example, propylene glycol monobutyl ether, propylene glycol dibutyl ether, dipropylene glycol monomethyl ether, dipropylene glycol monoethyl ether, dipropylene glycol monopropyl ether, dipropylene glycol monobutyl ether, tripropylene glycol monopropyl ether, tripropylene glycol monobutyl ether, tetrapropylene glycol monomethyl ether, dipropylene glycol dibutyl ether and tripropylene glycol dibutyl ether.

The lower alcohol includes, for example, aliphatic alcohols having 1-6 carbon atoms in one molecule. Concrete examples thereof include, for example, ethyl alcohol, propyl alcohol, isopropyl alcohol and butyl alcohol.

Of these water-soluble organic solvents, glycol solvents, glycol ethers, glycerin, diglycerin, triglycerin and polyglycerins are preferably used.

Also, concrete examples of the water-insoluble solvent include, for example, dimethyl carbonate and diethyl carbonate.

In the present invention, it is required that the difference in solubility parameter (SP value) between the solvent of the pre-treatment solution (I) or (II) and the solvent of the oil ink is not less than the predetermined value. Also, the smaller the particle diameter of the inorganic particle is, the easier the permeation of the inorganic particle itself between fibers of the printing paper is, and accordingly the larger the difference in SP value should be. When the average particle diameter of the inorganic particles to be used in the pre-treatment solution is not less then 1 μm and not more than 20 μm, the difference in SP value must be not less than 1.0 (cal/cm³)^{1/2}. Also, when the average particle diameter of the inorganic particles to be used in the pre-treatment solution is not less than 0.1 μm and less than 1 μm, the difference in SP values must be not less than 2.0 (cal/cm³)^{1/2}. When the difference in SP value is too small, the ink easily permeates due to the effect of the residual solvent in the printing medium and the dispersing agent used for dispersion of the particles, and thus filling property is lowered, printing density is not sufficiently improved, and strike through and bleeding easily occur.

As the organic solvent, is preferably used one with a solubility parameter of not less than 7.5 (cal/cm³)^{1/2} and not more than 17.0 (cal/cm³)^{1/2} and more preferably not less than 8.0 (cal/cm³)^{1/2} and not more than 17.0 (cal/cm³)^{1/2}.

The solvent of the pre-treatment solution may be composed of one or two or more selected from the group consisting of water and the above various organic compounds, but a solvent composed of only one selected from the above group is preferable because of easiness to obtain a solvent with the specific SP value. Meanwhile, it should be noticed that when water is used as the solvent of the pre-treatment solution, printing paper such as plain paper is deformed so that difficulty in conveyance of the printing medium is caused, thereby providing a inhibition factor for high-speed printing. In order to prevent this, it is preferable that the entire solvent of the pre-treatment solution is composed of an organic solvent.

### 2-1-3. Other Components

In addition to the above solvent and inorganic particles, other components such as dispersing agents, surfactants, fixing agents and antiseptics can be added to the pre-treatment solution (I) or (II) as long as they do not adversely affect the property thereof. Particularly, the fixing agent is useful for preventing bleeding of printed image. As the fixing agent, various water-soluble polymer or polymer particles capable of dispersing in water can be used. The preferable types of polymer include acrylic acid based copolymers, acryl/styrene copolymers, polyurethanes, polyesters, polyvinyl alcohol, polyvinyl chloride, polyvinyl acetate, styrene-butadiene rubber (SBR), starch, alkyd resins, polyacrylamide and polyvinyl acetal.

Of these, when water is used as the solvent of the pre-treatment solution (I) or (II), it is preferable to use, as the fixing agent, a polyvinyl alcohol that has a degree of polymerization of not more than 500 and a degree of saponification of not less than 60 mol % as used in the following pre-treatment solution (III). The following descriptions relating to polyvinyl alcohol for the pre-treatment solution (III) is wholly applicable to this case. When such a polyvinyl alcohol is used to perform printing at a relatively low resolution of not more than 300×300 dpi, high printing density can be obtained. Polyvinyl alcohol is contained in an amount of preferably 3.0-35.0 mass % and more preferably 6.0-30.0 mass % relative to the amount of inorganic particles. When the addition amount of polyvinyl alcohol is too much, dot size is increased and brightness becomes high, and thus image quality is lowered.

Also, when the addition amount of polyvinyl alcohol is too small, the coating layer itself is lowered in strength and becomes easy to peel off from the surface of the printing medium.

### 2-1-4. Production Method of the Pre-Treatment Solutions (I) and (II)

The pre-treatment solution (I) or (II) used in the present invention can be prepared by putting the whole or part of the components in a known dispersing machine such as a beads mill to obtain a dispersion and if necessary passing it through a known filtering machine such as a membrane filter. For example, it can be prepared by previously mixing part of the solvent with the whole of the inorganic particles uniformly and dispersing the mixture in a dispersing machine, and then adding the rest of the components to the resulting dispersion followed by filtration.

### 2-2. Pre-Treatment Solution (III)

The pre-treatment solution (III) used in the present invention is mainly composed of inorganic particles, a polyvinyl alcohol and water, and may comprise other components, if required.

### 2-2-1. Inorganic Particles

As the inorganic particle, those mentioned above concerning the pre-treatment solution (I) or (II) can be used, and beside colloidal silica and the like can be used. The average particle diameter of the inorganic particles is preferably not more than 15 μm and more preferably not more than 12 μm. When the average particle diameter is larger than 15 μm, the effect of filling the printing medium is insufficient, and improvement of printing density may not be sufficiently obtained. The inorganic particles preferably have a specific gravity of 0.1-5.7.

The inorganic particles are contained in an amount of preferably 0.01-40 mass % and more preferably 5-30 mass % relative to the total amount of the pre-treatment solution (III).

### 2-2-2. Dispersing Agents for Inorganic Particles

The dispersing agent for the inorganic particles is not particularly limited as long as it has an ionic character similar to polyvinyl alcohol. Examples of the dispersing agent that can be used include “DEMOL P, EP, POIZ 520, 521, 530, HOMOGENOL L-18 (polycarboxylate type polymer surfactants)” (all trade names) available from Kao Corporation, and “SHALLOL DC303P and DC-902P” (quaternary ammonium salt type polymer surfactant) (both trade names) available from Dai-ichi Kogyo Seiyaku Co., Ltd.

### 2-2-3. Polyvinyl Alcohol

Polyvinyl alcohol is not particularly limited as long as it has a degree of polymerization of not more than 500 and a degree of saponification of not less than 60 mol %, and can be those available from various manufacturers. A preferable polyvinyl alcohol is one which dissolves uniformly without granular appearance to become a clear liquid entirely, when it is added to and dissolved in water at 100° C. for 30 minutes under stirring. When the degree of polymerization exceeds 500, ink stain on rollers inside printing devices and on continuously printed printing paper are not sufficiently inhibited upon printing. Also, when the degree of saponification is less than 60 mol %, ink stain on rollers inside printing devices and on continuously printed printing paper are not sufficiently inhibited upon printing. The degree of polymerization is preferably 180-500 and more preferably 250-500. The degree of saponification is preferably not less than 64 mol %.

Polyvinyl alcohol is contained in an amount of preferably 10.0-35.0 mass %, and more preferably 20.0-30.0 mass % relative to the amount of the inorganic particles. When the addition amount of polyvinyl alcohol is too much, dot size during inkjet printing increases, brightness of dots becomes high, and thus image quality is lowered. Also, when the addition amount of polyvinyl alcohol is too small, dot brightness is lowered and image quality is good, but the coated layer itself is lowered in strength and becomes easy to peel off from the surface of the printing medium.

### 2-2-4. Water

Water of the pre-treatment solution (III) is not particularly limited as long as it does not affect dispersion ability of the inorganic particles and polyvinyl alcohol in the pre-treatment solution, and may be tap water, ion-exchanged water and the like.

### 2-2-5. Other Components

In addition to water, inorganic particles, dispersing agents therefor and polyvinyl alcohol, other components such as surfactants, fixing agents and antiseptics can be added to the pre-treatment solution (III) as long as they do not adversely affect the property thereof.

### 2-2-6. Production Method of the Pre-Treatment (III)

The pre-treatment solution (III) used in the present invention can be prepared by putting the whole or part of the components in a known dispersing machine such as a beads mill to obtain a dispersion and if necessary passing it through a known filtering machine such as a membrane filter. A method in which polyvinyl alcohol is dissolved in water, and then a dispersing agent is dissolved therein, and lastly inorganic particles are added and stirred until it becomes uniform is suitable.

### 3. Printing Method

In the present invention, the printing method is not particularly limited as long as it is a printing method using an oil ink, and inkjet printing is suitable.

According to the present invention, the inkjet printing method is performed by applying a pre-treatment solution onto a printing medium, and then ejecting an oil ink on the printing medium. The application of the pre-treatment solution onto the printing medium can be performed by uniformly coating a surface of the printing medium using a brush, roller, bar coater or the like, or printing an image with printing means such as inkjet printing and gravure printing. For example, printing may be performed by ejecting the pre-treatment solution onto a printing medium, and then successively ejecting the oil ink using the inkjet printer so as to overlay it on the pre-treatment solution that has been ejected onto the printing medium. Meanwhile, in the present invention, after the pre-treatment solution is applied onto the printing medium, the oil ink may be ejected before the applied pre-treatment solution is dried, or the oil ink may be ejected after the applied pre-treatment solution is dried, but it is preferable to that the oil ink is ejected after the applied pre-treatment solution is dried by permeation or evaporation. Particularly when a pre-treatment solution (I) or (II) containing a large amount of water is used, drying step may be added before the oil ink is printed. The drying step can be conducted by known methods such as blowing a hot wind to the printing medium or conveying the printing medium under a heated roll after the application of the pre-treatment solution.

It is advantageous to constitute and market an ink set comprising at least an above pre-treatment solution and an oil ink in order to make it easier to carry out the printing method of the present invention, particularly the inkjet printing method.

In the present invention, the printing medium is not particularly limited, and may be plain paper, glossy paper, specialty paper, fabrics, films, OHP sheets, and the like. Especially, according to the present invention, even when printing is performed on plain paper, coloring materials stay on the surface of printing paper without permeating through the printing paper, and thus great advantages result including improvement of printing density and decrease in strike through and bleeding, and also prevention of curling of printing paper during printing without prevention of high-speed printing. Also, when the above polyvinyl alcohol is added to the pre-treatment solution like the pre-treatment solution (III), great advantages result including prevention of ink stain on rollers inside printing devices and on continuously printed printing paper.

### EXAMPLE

Hereinafter, the present invention will be described in detail by way of Examples and Comparative Examples, however, the present invention is not limited to these examples.

### Examples I-1 to I-4

### Comparative Examples I-1 to I-4

### (1) Preparation of the Pre-Treatment Solution Containing Inorganic Particles

The components shown in Table 1 were premixed in the ratio shown in Table 1, and then the mixture was dispersed in a beads mill (using zirconium beads having a diameter (φ) of 2.0 mm). The resulting dispersion was filtered with a nylon mesh (having pores of 200 μm in diameter) to obtain a pre-treatment solution.

### (2) Preparation of the Oil Ink

The components shown in Table 1 were premixed in the ratio shown in Table 1, and then zirconium beads having a diameter (φ) of 0.5 mm were placed therein, and the mixture was dispersed in a Rocking Mill (manufactured by Seiwa Giken Co., Ltd.) for 60 minutes. The resulting dispersion was filtered with a membrane filter (having pores of 3 μm in diameter) to prepare a black ink.

TABLE 1

| | | | | Ex. | Ex. | Ex. | Ex. | Comp. | Comp. | Comp. | Comp. |
|---|---|---|---|---|---|---|---|---|---|---|---|
| | | | | I-1 | I-2 | I-3 | I-4 | Ex. I-1 | Ex. I-2 | Ex. I-3 | Ex. I-4 |
| Composition | Inorganic | MIZUKASIL P-50 | Ave. particle | 20.0 | 20.0 | 20.0 | 20.0 | — | 20.0 | 20.0 | 20.0 |
| of | particles | | diameter 8.0 μm | | | | | | | | |
| pre-treatment | | BRILLIANT-15 | Ave. particle | — | — | — | — | — | — | — | — |
| solution | | | diameter 0.15 μm | | | | | | | | |
| | Dispersing | DEMOL EP | Solid matter 25 mass % | 4.0 | 4.0 | — | — | — | — | — | — |
| | agent | SOLSPERSE 24000 | Solid matter 100 mass % | — | — | 1.0 | 1.0 | — | 1.0 | — | — |
| | | SOLSPERSE 11200 | Solid matter 50 mass % | — | — | — | — | — | — | 2.0 | 2.0 |
| | Polymer | HARIDIP H-541 | Solid matter 65 mass % | 3.1 | 3.1 | 3.1 | — | — | — | — | — |
| | compound | HARIPHTHAL | Solid matter 50 mass % | — | — | — | 4.0 | — | 4.0 | — | — |
| | | 3258P-N150 | | | | | | | | | |
| | | HARIPHTHAL | Solid matter 55 mass % | — | — | — | — | — | — | 3.6 | 3.6 |
| | | 193HV | | | | | | | | | |
| | Solvent | Water | SP value 23.4 | 72.9 | — | — | — | — | — | — | — |
| | | | (cal/cm³)^{1/2} | | | | | | | | |
| | | Ethyleneglycol | SP value 14.6 | — | 72.9 | — | — | — | — | — | — |
| | | | (cal/cm³)^{1/2} | | | | | | | | |
| | | Diethyleneglycol- | SP value 10.9 | — | — | 75.9 | — | — | — | — | — |
| | | m-ethylether | (cal/cm³)^{1/2} | | | | | | | | |
| | | Demethyl carbonate | SP value 9.9 (cal/cm³)^{1/2} | — | — | — | 75.0 | — | — | — | — |
| | | Diethyleneglycol-m- | SP value 9.0 (cal/cm³)^{1/2} | — | — | — | — | — | 75.0 | — | — |
| | | ethylether acetate | | | | | | | | | |
| | | Dodecane | SP value 7.9 (cal/cm³)^{1/2} | — | — | — | — | — | — | 74.4 | — |
| | | ISOPAR-H | SP value 7.3 (cal/cm³)^{1/2} | — | — | — | — | — | — | — | 74.4 |
| | Total (part) | | | 100.0 | 100.0 | 100.0 | 100.0 | — | 100.0 | 100.0 | 25.6 |
| Composition | Pigment | MA-11 | Solid matter 100 mass % | 8.0 | ← | ← | ← | ← | ← | ← | ← |
| of oil ink | Dispersing | SOLSPERSE 28000 | Solid matter 100 mass % | 2.0 | ← | ← | ← | ← | ← | ← | ← |
| | agent | | | | | | | | | | |
| | Organic | EXCEPARL M-OL | SP value 8.4 (cal/cm³)^{1/2} | 30.0 | ← | ← | ← | ← | ← | ← | ← |
| | solvent | EXCEPARL IPM | SP value 8.1 (cal/cm³)^{1/2} | 30.0 | ← | ← | ← | ← | ← | ← | ← |
| | | NORMAL | SP value 7.9 (cal/cm³)^{1/2} | 30.0 | ← | ← | ← | ← | ← | ← | ← |
| | | PARAFFIN H | | | | | | | | | |

| | Total (part) | 100.0 | ← | ← | ← | ← | ← | ← | ← |
|---|---|---|---|---|---|---|---|---|---|
| SP value of pre-treatment solution solvent (cal/cm³)^{1/2} | | 23.4 | 14.6 | 10.9 | 9.9 | — | 9.0 | 7.9 | 7.3 |
| SP value of oil ink solvent (cal/cm³)^{1/2} | | 8.1 | 8.1 | 8.1 | 8.1 | 8.1 | 8.1 | 8.1 | 8.1 |
| Difference in SP value between pre-treatment solution | | 15.3 | 6.5 | 2.8 | 1.8 | — | 0.9 | 0.2 | 0.8 |
| solvent and oil ink solvent (cal/cm³)^{1/2} | | | | | | | | | |
| *absolute value | | | | | | | | | |
| Evaluation | Printing density | ⊚ | ◯ | ◯ | ◯ | X | X | X | X |
| result | | 1.22 | 1.12 | 1.11 | 1.10 | 1.02 | 1.09 | 0.93 | 0.93 |
| | Strike through | ◯ | ◯ | ⊚ | ◯ | X | ◯ | X | X |
| | | 0.21 | 0.22 | 0.20 | 0.21 | 0.24 | 0.21 | 0.36 | 0.32 |
| | Bleeding of dots | ⊚ | ◯ | ◯ | ◯ | X | X | X | X |

Meanwhile, SP value (δₘᵢₓ) of the oil ink solvent as a mixed solvent of three organic solvents was calculated in accordance with the following equation (2).

δₘᵢₓ=δ_{A}φ_{A}+δ_{B}φ_{B}+δ_{C}φ_{C} (2)

δ_{A}, δ_{B}, δ_{C}: SP values of the solvents A, B and C, respectively.
φ_{A}, φ_{B}, φ_{C}: Volume fraction of the solvents A, B and C, respectively.

Details of the materials shown in Table 1 mean as follows.

MIZUKASIL P-50: “MIZUKASIL P-50 (trade name)” (silica powder) available from MIZUSAWA INDUSTRIAL CHEMICALS, LTD.
BRILLIANT-15: “BRILLIANT-15 (trade name)” (a colloidal calcium carbonate powder with average particle diameter of 150 nm) available from Shiraishi Kogyo Kaisha, Ltd.
DEMOL EP: “DEMOL EP (trade name)” (special polycarboxylate type polymer surfactant; solid content 25%) available from Kao Corporation.
SOLSPERSE 24000: “SOLSPERSE 24000 (trade name)” (polymer dispersing agent) available from Lubrizol Japan Ltd.
SOLSPERSE 11200: “SOLSPERSE 11200 (trade name)” (polymer dispersing agent) available from Lubrizol Japan Ltd.
HARIDIP H-541: “HARIDIP H-541 (trade name)” (acryl-modified alkyd resin) available from HARIMA CHEMICALS, INC.
HARIPHTHAL 3258P-N150: “HARIPHTHAL 3258P-N150 (trade name)” (phenol-modified alkyd resin) available from HARIMA CHEMICALS, INC.
HARIPHTHAL 193HV: “HARIPHTHAL 193HV (trade name)” (phenol-modified alkyd resin) available from HARIMA CHEMICALS, INC.
ISOPAR H: “ISOPAR H (trade name)” (isoparaffinic solvent) available from Exxon Mobil Corporation.
MA-11: “MA-11 (trade name)” (carbon black) available from Mitsubishi Chemical Corporation.
SOLSPERSE 28000: “SOLSPERSE 28000 (trade name)” (a pigment dispersing agent) available from Lubrizol Japan Ltd.
EXCEPARL M-OL: “EXCEPARL M-OL (trade name)” (methyl oleate) available from Kao Corporation.
EXCEPARL IPM: “EXCEPARL IPM (trade name)” (isopropyl myristate) available from Kao Corporation.
NORMAL PARAFFIN H: “NORMAL PARAFFIN H (trade name)” (hydrocarbon solvent) available from Nippon Oil Corporation.

### (3) Inkjet Printing

The oil ink shown in Table 1 was introduced into the ejection route of the inkjet printer HC5500 (trade name; manufactured by RISO KAGAKU CORPORATION). Using plain paper (RISO-YOSHI, USUKUCHI (trade name; manufactured by RISO KAGAKU CORPORATION)) as printing paper, the pre-treatment solution shown in Table 1 was coated on an entire surface on one side of the printing paper with a coating roller so that a solid matter after drying was 1.0 g/m², and a solvent was dried with a dryer. Then, the oil ink was ejected onto the treated surface of the printing paper to print solid image and independent dots. Printing was carried out under the condition that the resolution was 300×300 dpi, and the ink amount was 30 pl/dot. Printing density, strike through and bleeding of dots of the resulting prints were evaluated in accordance with the following standards. The results are shown in Table 1.

Printing density of prints: Printing density (OD) of the solid image surface of the resulting print was measured with an optical densitometer (RD920; manufactured by Macbeth) and evaluated in accordance with the following standards.

### Evaluation Standards:

⊚: 1.20≦OD value
◯: 1.10≦OD value<1.20
X: OD value<1.10

Strike through of prints: Printing density (OD) of the back face of the solid image of the resulting print was measured with an optical densitometer (RD920; manufactured by Macbeth) and evaluated in accordance with the following standards.

⊚: OD value≦0.20
◯: 0.20<OD value≦0.22
X: 0.22<OD value

Bleeding of dots: 840 independent dots were photographed through a microscope, and the resulting photo image was changed to grayscale. Then, an average area of the dots was measured with an image analysis software “IMAGE PRO PLUS (trade name)” available from Nippon Roper K.K., and evaluated as bleeding of the dots in accordance with the following standards.

### Evaluation Standards:

⊚: 7500 μm²<average area of printed dots≦13000 μm².
◯: 13000 μm²<average area of printed dots≦15000 μm².
X: 15000 μm²<average area of printed dots

The followings are found from the results of Table 1.

In Examples I-1 to I-4 in which the pre-treatment solution of the present invention was used, sufficient printing density was obtained, and strike through was also prevented. In contrast, in Comparative Example I-1 in which no pre-treatment solution was used, printing density was low, and strike through and bleeding occurred. Also, in Comparative Examples I-2 to I-4 in which the difference in solubility parameter (SP value) between the solvent of the pre-treatment solution and the solvent of the oil ink was less than 1.0 (cal/cm³)^{1/2}, printing density was low, and strike through and bleeding occurred.

### Example I-5 to I-7

### Comparative Example I-5 to I-8

Experiment was conducted in the same manner as in Example I-1 except that the composition of Table 2 was used instead of Table 1.

TABLE 2

| | | | | Ex. | Ex. | Ex. | Comp. | Comp. | Comp. | Comp. |
|---|---|---|---|---|---|---|---|---|---|---|
| | | | | I-5 | I-6 | I-7 | Ex. I-5 | Ex. I-6 | Ex. I-7 | Ex. I-8 |
| Composition | Inorganic | MIZUKASIL P-50 | Ave. particle | — | — | — | — | — | — | — |
| of | particles | | diameter 8.0 μm | | | | | | | |
| pre-treatment | | BRILLIANT-15 | Ave. particle diameter | 20.0 | 20.0 | 20.0 | 20.0 | 20.0 | 20.0 | 20.0 |
| solution | | | 0.15 μm | | | | | | | |
| | Dispersing | DEMOL EP | Solid matter 25 mass % | 4.0 | 4.0 | — | — | — | — | — |
| | agent | SOLSPERSE 24000 | Solid matter 100 mass % | — | — | 1.0 | 1.0 | 1.0 | — | — |
| | | SOLSPERSE 11200 | Solid matter 50 mass % | — | — | — | — | — | 2.0 | 2.0 |
| | Polymer | HARIDIP H-541 | Solid matter 65 mass % | — | 3.1 | 3.1 | — | — | — | — |
| | compound | HARIPHTHAL | Solid matter 50 mass % | — | — | — | 4.0 | 4.0 | — | — |
| | | 3258P-N150 | | | | | | | | |
| | | HARIPHTHAL 193HV | Solid matter 55 mass % | — | — | — | — | — | 3.6 | 3.6 |
| | Solvent | Water | SP value 23.4 (cal/cm³)^{1/2} | 74.0 | — | — | — | — | — | — |
| | | Ethyleneglycol | SP value 14.6 (cal/cm³)^{1/2} | — | 72.9 | — | — | — | — | — |
| | | Diethyleneglycol-m- | SP value 10.9 (cal/cm³)^{1/2} | — | — | 75.9 | — | — | — | — |
| | | ethylether | | | | | | | | |
| | | Demethyl carbonate | SP value 9.9 (cal/cm³)^{1/2} | — | — | — | 75.0 | — | — | — |
| | | Diethyleneglycol-m- | SP value 9.0 (cal/cm³)^{1/2} | — | — | — | — | 75.0 | — | — |
| | | ethylether acetate | | | | | | | | |
| | | Dodecane | SP value 7.9 (cal/cm³)^{1/2} | — | — | — | — | — | 74.4 | — |
| | | ISOPER-H | SP value 7.3 (cal/cm³)^{1/2} | — | — | — | — | — | — | 74.4 |
| | Total (part) | | | 98.0 | 100.0 | 100.0 | 100.0 | 100.0 | 100.0 | 100.0 |
| Composition | Pigment | MA-11 | Solid matter 100 mass % | 8.0 | ← | ← | ← | ← | ← | ← |
| of oil ink | Dispersing | SOLSPERSE 28000 | Solid matter 100 mass % | 2.0 | ← | ← | ← | ← | ← | ← |
| | agent | | | | | | | | | |
| | Organic | EXCEPARL M-OL | SP value 8.4 (cal/cm³)^{1/2} | 30.0 | ← | ← | ← | ← | ← | ← |
| | solvent | EXCEPARL IPM | SP value 8.1 (cal/cm³)^{1/2} | 30.0 | ← | ← | ← | ← | ← | ← |
| | | NORMAL PARAFFIN H | SP value 7.9 (cal/cm³)^{1/2} | 30.0 | ← | ← | ← | ← | ← | ← |

| | Total (part) | 100.0 | ← | ← | ← | ← | ← | ← |
|---|---|---|---|---|---|---|---|---|
| SP value of pre-treatment solution solvent (cal/cm³)^{1/2} | | 23.4 | 14.6 | 10.9 | 9.9 | 9.0 | 7.9 | 7.3 |
| SP value of oil ink solvent (cal/cm³)^{1/2} | | 8.1 | 8.1 | 8.1 | 8.1 | 8.1 | 8.1 | 8.1 |
| Difference in SP value between pre-treatment solution | | 15.3 | 6.5 | 2.8 | 1.8 | 0.9 | 0.2 | 0.8 |
| solvent and oil ink solvent (cal/cm³)^{1/2} | | | | | | | | |
| Evaluation | Printing density | ⊚ | ◯ | ◯ | X | X | X | X |
| result | | 1.26 | 1.12 | 1.12 | 0.99 | 0.95 | 1.07 | 1.02 |
| | Strike through | ◯ | ⊚ | ⊚ | ⊚ | ⊚ | X | X |
| | | 0.21 | 0.19 | 0.18 | 0.17 | 0.16 | 0.24 | 0.26 |
| | Bleeding of dots | ⊚ | ◯ | ◯ | ◯ | ◯ | X | X |

Details of the materials shown in Table 2 are the same as in Table 1.

The followings are found from the results of Table 2.

In Examples I-5 to I-7 in which the pre-treatment solution of the present invention was used, sufficient printing density was obtained, and strike through was also prevented. In contrast, in Comparative Examples I-5 to I-8 in which the difference in solubility parameter (SP value) between the solvent of the pre-treatment solution and the solvent of the oil ink was less than 2.0 (cal/cm³)^{1/2}, printing density was low, and in Comparative Examples I-7 and I-8, strike through and bleeding occurred.

### Examples I-8 to I-17

### Comparative Example I-9

### (1) Preparation of the Pre-Treatment Solution Containing Inorganic Particles

The components shown in Table 3 were premixed in the ratio shown in Table 3, and then the mixture was dispersed in an ultrasonic dispersing machine for 1 minute to obtain the resulting dispersion as the pre-treatment solution.

### (2) Preparation of the Oil Ink

The components shown in Table 3 were premixed in the ratio shown in Table 3, and then zirconium beads having a diameter (φ) of 0.5 mm were placed therein, and the mixture was dispersed in a Rocking Mill (manufactured by Seiwa Giken Co., Ltd.) for 60 minutes. The resulting dispersion was filtered with a membrane filter (having pores of 3 μm in diameter) to prepare a black ink.

TABLE 3

| | | | | Ex. | Ex. | Ex. | Ex. | Ex. | Ex. |
|---|---|---|---|---|---|---|---|---|---|
| | | | | I-8 | I-9 | I-10 | I-11 | I-12 | I-13 |
| Composition | Inorganic | MIZUKASIL P-758 | Ave. particle diameter 13.0 μm | — | — | — | — | — | — |
| of | particles | MIZUKASIL P-50 | Ave. particle diameter 8.0 μm | 13.0 | — | — | — | — | — |
| pre-treatment | | MIZUKASIL P-73 | Ave. particle diameter 4.0 μm | — | 13.0 | — | — | — | 13.0 |
| solution | | MIZUKASIL P-78F | Ave. particle diameter 18.0 μm | — | — | — | — | — | — |
| | | MIZUKASIL P-78D | Ave. particle diameter 12.0 μm | — | — | 13.0 | — | — | — |
| | | MIZUKASIL P-78A | Ave. particle diameter 6.0 μm | — | — | — | 13.0 | — | — |
| | | MIZUKASIL P-709 | Ave. particle diameter 8.0 μm | — | — | — | — | 13.0 | — |
| | | MIZUKASIL P-526 | Ave. particle diameter 7.0 μm | — | — | — | — | — | — |
| | Dispersing | SHALLOL DC-902P | Solid matter 51 mass % | 1.2 | ← | ← | ← | ← | ← |
| | agent | | | | | | | | |
| | Polymer | SUPERFLEX 620 | Solid matter 30 mass % | 2.9 | ← | ← | ← | ← | ← |
| | compound | | | | | | | | |
| | PVA | RS-1704 | Degree of polymerization 400 | 0.9 | ← | ← | ← | ← | ← |
| | Solvent | Water | SP value 23.4 (cal/cm³)^{1/2} | 82.0 | ← | ← | ← | ← | ← |
| | Total (part) | | | 100.0 | ← | ← | ← | ← | ← |
| Composition | Pigment | MA-11 | Solid matter 100 mass % | 8.0 | ← | ← | ← | ← | ← |
| of oil ink | Dispersing | SOLSPERSE 28000 | Solid matter 100 mass % | 2.0 | ← | ← | ← | ← | ← |
| | agent | | | | | | | | |
| | Organic solvent | EXCEPARL M-OL | SP value 8.4 (cal/cm³)^{1/2} | 30.0 | ← | ← | ← | ← | ← |
| | | EXCEPARL IPM | SP value 8.1 (cal/cm³)^{1/2} | 30.0 | ← | ← | ← | ← | ← |
| | | NORMAL | SP value 7.9 (cal/cm³)^{1/2} | 30.0 | ← | ← | ← | ← | ← |
| | | PARAFFIN H | | | | | | | |

| | | | | | | |
|---|---|---|---|---|---|---|
| Total (part) | 100.0 | ← | ← | ← | ← | ← |

| SP value of pre-treatment solution solvent (cal/cm³)^{1/2} | | | 23.4 | ← | ← | ← | ← | ← |
|---|---|---|---|---|---|---|---|---|
| SP value of oil ink solvent (cal/cm³)^{1/2} | | | 8.1 | ← | ← | ← | ← | ← |
| Difference in SP value between pre-treatment solution solvent and oil ink | | | 15.3 | ← | ← | ← | ← | ← |
| solvent (cal/cm³)^{1/2} | | | | | | | | |
| Coating amount of inorganic particles of pre-treatment solution (g/m²) | | | 0.97 | 0.97 | 0.97 | 0.97 | 0.97 | 1.5 |
| Property of inorganic | Ave. particle | (μm) | 8.0 | 4.0 | 12.0 | 6.0 | 8.0 | 4.0 |
| particles of pre- | diameter | | | | | | | |
| treatment solution | Oil absorption | (ml/100 g) | 170.0 | 180.0 | 240.0 | 250.0 | 250.0 | 180.0 |
| | Specific surface area | (m²/g) | 330.0 | 330.0 | 360.0 | 360.0 | 300.0 | 330.0 |
| | Liquid absorbency | Oil absorption/Specific | 0.52 | 0.55 | 0.67 | 0.69 | 0.83 | 0.55 |
| | (A) | surface area | | | | | | |
| Evaluation result | Printing density | OD value | 1.31 | 1.39 | 1.39 | 1.39 | 1.37 | 1.31 |
| | | Evaluation | ⊚ | ⊚ | ⊚ | ⊚ | ⊚ | ⊚ |
| | Strike through | OD value | 0.20 | 0.18 | 0.18 | 0.18 | 0.18 | 0.16 |
| | | Evaluation | ⊚ | ⊚ | ⊚ | ⊚ | ⊚ | ⊚ |
| | Bleeding of dots | Dot average area (μm²) | 12378 | 10249 | 9450 | 9420 | 9604 | 9674 |
| | | Evaluation | ⊚ | ⊚ | ⊚ | ⊚ | ⊚ | ⊚ |

| | | | | Ex. | Ex. | Ex. | Ex. | Comp. |
|---|---|---|---|---|---|---|---|---|
| | | | | I-14 | I-15 | I-16 | I-17 | Ex. I-9 |
| Composition | Inorganic particles | MIZUKASIL P-758 | Ave. particle diameter 13.0 μm | — | — | 13.0 | — | — |
| of | | MIZUKASIL P-50 | Ave. particle diameter 8.0 μm | — | — | — | — | — |
| pre-treatment | | MIZUKASIL P-73 | Ave. particle diameter 4.0 μm | 13.0 | — | — | — | — |
| solution | | MIZUKASIL P-78F | Ave. particle diameter 18.0 μm | — | 13.0 | — | — | — |
| | | MIZUKASIL P-78D | Ave. particle diameter 12.0 μm | — | — | — | — | — |
| | | MIZUKASIL P-78A | Ave. particle diameter 6.0 μm | — | — | — | — | — |
| | | MIZUKASIL P-709 | Ave. particle diameter 8.0 μm | — | — | — | — | — |
| | | MIZUKASIL P-526 | Ave. particle diameter 7.0 μm | — | — | — | 13.0 | — |
| | Dispersing agent | SHALLOL DC-902P | Solid matter 51 mass % | ← | ← | ← | ← | — |
| | Polymer compound | SUPERFLEX 620 | Solid matter 30 mass % | ← | ← | ← | ← | — |
| | PVA | RS-1704 | Degree of polymerization 400 | ← | ← | ← | ← | — |
| | Solvent | Water | SP value 23.4 (cal/cm³)^{1/2} | ← | ← | ← | ← | — |
| | Total (part) | | | ← | ← | ← | ← | — |
| Composition | Pigment | MA-11 | Solid matter 100 mass % | ← | ← | ← | ← | ← |
| of oil ink | Dispersing agent | SOLSPERSE 28000 | Solid matter 100 mass % | ← | ← | ← | ← | ← |
| | Organic solvent | EXCEPARL M-OL | SP value 8.4 (cal/cm³)^{1/2} | ← | ← | ← | ← | ← |
| | | EXCEPARL IPM | SP value 8.1 (cal/cm³)^{1/2} | ← | ← | ← | ← | ← |
| | | NORMAL | SP value 7.9 (cal/cm³)^{1/2} | ← | ← | ← | ← | ← |
| | | PARAFFIN H | | | | | | |

| | | | | | |
|---|---|---|---|---|---|
| Total (part) | ← | ← | ← | ← | ← |

| SP value of pre-treatment solution solvent (cal/cm³)^{1/2} | | | ← | ← | ← | ← | ← |
|---|---|---|---|---|---|---|---|
| SP value of oil ink solvent (cal/cm³)^{1/2} | | | ← | ← | ← | ← | ← |
| Difference in SP value between pre-treatment solution solvent and oil ink | | | ← | ← | ← | ← | ← |
| solvent (cal/cm³)^{1/2} | | | | | | | |
| Coating amount of inorganic particles of pre-treatment solution (g/m²) | | | 2.0 | 0.97 | 1.5 | 0.5 | — |
| Property of inorganic | Ave. particle | (μm) | 4.0 | 18.0 | 13.0 | 7.0 | — |
| particles of pre- | diameter | | | | | | |
| treatment solution | Oil absorption | (ml/100 g) | 180.0 | 230.0 | 134.0 | 240.0 | — |
| | Specific surface area | (m²/g) | 330.0 | 380.0 | 530.0 | 180.0 | — |
| | Liquid absorbency | Oil absorption/Specific | 0.55 | 0.61 | 0.25 | 1.33 | — |
| | (A) | surface area | | | | | |
| Evaluation result | Printing density | OD value | 1.26 | 1.21 | 1.26 | 1.17 | 1.03 |
| | | Evaluation | ⊚ | ⊚ | ⊚ | ◯ | X |
| | Strike through | OD value | 0.14 | 0.22 | 0.21 | 0.17 | 0.25 |
| | | Evaluation | ⊚ | ◯ | ◯ | ⊚ | X |
| | Bleeding of dots | Dot average area (μm²) | 8447 | 13966 | 12856 | 7553 | 17605 |
| | | Evaluation | ⊚ | ◯ | ⊚ | ⊚ | X |

Meanwhile, SP value (δₘᵢₓ) of the oil ink solvent as a mixed solvent of three organic solvents was calculated in accordance with the above equation (2).

Details of the materials shown in Table 3 mean as follows.

MIZUKASIL P-758: “MIZUKASIL P-758 (trade name)” (silica powder) available from MIZUSAWA INDUSTRIAL CHEMICALS, LTD.
MIZUKASIL P-50: “MIZUKASIL P-50 (trade name)” (silica powder) available from MIZUSAWA INDUSTRIAL CHEMICALS, LTD.
MIZUKASIL P-73: “MIZUKASIL P-73 (trade name)” (silica powder) available from MIZUSAWA INDUSTRIAL CHEMICALS, LTD.
MIZUKASIL P-78F: “MIZUKASIL P-78F (trade name)” (silica powder) available from MIZUSAWA INDUSTRIAL CHEMICALS, LTD.
MIZUKASIL P-78D: “MIZUKASIL P-78D (trade name)” (silica powder) available from MIZUSAWA INDUSTRIAL CHEMICALS, LTD.
MIZUKASIL P-78A: “MIZUKASIL P-78A (trade name)” (silica powder) available from MIZUSAWA INDUSTRIAL CHEMICALS, LTD.
MIZUKASIL P-709: “MIZUKASIL P-709 (trade name)” (silica powder) available from MIZUSAWA INDUSTRIAL CHEMICALS, LTD.
MIZUKASIL P-526: “MIZUKASIL P-526 (trade name)” (silica powder) available from MIZUSAWA INDUSTRIAL CHEMICALS, LTD.
SHALLOL DC-902P: “SHALLLOL DC-902P” (polydiaryldimethylammonium chloride) available from Dai-ichi Kogyo Seiyaku Co., Ltd.
SUPERFLEX 620: “SUPERFLEX 620” (aqueous polyurethane resin emulsion) available from Dai-ichi Kogyo Seiyaku Co. Ltd.
RS-1704: “RS-1704” (polyvinyl alcohol with degree of saponification of 93.0 mol % and degree of polymerization of 400) available from KURARAY CO., LTD.
MA-11: “MA-11 (trade name)” (carbon black) available from Mitsubishi Chemical Corporation.
SOLSPERSE 28000: “SOLSPERSE 28000 (trade name)” (a pigment dispersing agent) available from Lubrizol Japan Ltd.
EXCEPARL M-OL: “EXCEPARL M-OL (trade name)” (methyl oleate) available from Kao Corporation.
EXCEPARL IPM: “EXCEPARL IPM (trade name)” (isopropyl myristate) available from Kao Corporation.
NORMAL PARAFFIN H: “NORMAL PARAFFIN H (trade name)” (hydrocarbon solvent) available from Nippon Oil Corporation.

### (3) Inkjet Printing

The oil ink shown in Table 3 was introduced into the ejection route of the inkjet printer HC5500 (trade name; manufactured by RISO KAGAKU CORPORATION). Using plain paper “RISO-YOSHI, USUKUCHI (trade name)” manufactured by RISO KAGAKU CORPORATION as printing paper, the pre-treatment solution shown in Table 3 was coated on the entire surface on one side of the printing paper in a coating amount shown in Table 3 with a coating roller, and a solvent was dried with a heat roll. Then, the oil ink was ejected onto the treated surface of the printing paper to print solid image and independent dots. Printing was carried out under the condition that the resolution was 300×300 dpi, and the ink amount was 30 pl/dot. Printing density, strike through and bleeding of dots of the resulting prints were evaluated in accordance with the following standards. The results are shown in Table 3.

Printing density of prints: Printing density (OD) of the solid image surface of the resulting print was measured with an optical densitometer (RD920: manufactured by Macbeth) and evaluated in accordance with the following standards.

### Evaluation Standards:

⊚: 1.20≦OD value
◯: 1.10≦OD value<1.20
X: OD value<1.10

Strike through of prints: Printing density (OD) of the back face of the solid image of the resulting print was measured with an optical densitometer (RD920; manufactured by Macbeth) and evaluated in accordance with the following standards.

⊚: OD value≦0.20
◯: 0.20<OD value≦0.22
X: 0.22<OD value

Bleeding of dots: 840 independent dots were photographed through a microscope, and the resulting photo image was changed to grayscale. Then, an average area of the dots was measured with an image analysis software “IMAGE PRO PLUS (trade name)” available from Nippon Roper K.K., and evaluated as bleeding of the dots in accordance with the following standards.

### Evaluation Standards:

⊚: 7500 μm²<average area of printed dots≦13000 μm².
◯: 13000 μm²<average area of printed dots≦15000 μm².
X: 15000 μm²<average area of printed dots.

The followings are found from the results of Table 3.

In Examples I-8 to I-17 in which the pre-treatment solution containing silica particles with a preferable liquid absorbency (A) in the present invention was used, sufficient printing density was obtained, and strike through was also prevented. In contrast, in Comparative Example I-9 in which no pre-treatment solution was used, printing density was low, and strike through and bleeding were increased.

### Production Example 1

### Preparation of a Pre-Treatment Solution

The components shown in Table 4 were premixed in the ratio shown in Table 4, and then the mixture was dispersed in a beads mill (using zirconium beads having a diameter (φ) of 2.0 mm). The resulting dispersion was filtered with a membrane filter (having pores of 200 μm in diameter) to obtain a pre-treatment solution.

TABLE 4

| | | | | Pre- | Pre- | Pre- | Pre- | Pre- | Pre- | Pre- |
|---|---|---|---|---|---|---|---|---|---|---|
| | | | | treatment | treatment | treatment | treatment | treatment | treatment | treatment |
| | | | | solution 1 | solution 2 | solution 3 | solution 4 | solution 5 | solution 6 | solution 7 |
| Inorganic | BRILLIANT-15 | | | 20 | 20 | 20 | 20 | 20 | 20 | 20 |
| particles | | | | | | | | | | |
| Dispersing | DEMOL EP | Solid matter 25% | | 4 | 4 | 4 | 4 | 4 | 4 | 4 |
| agent | | | | | | | | | | |
| Polyvinyl | JMR-8M | Degree of | Degree of | 5 | | | | | | |
| alcohol | | saponification | polymerization | | | | | | | |
| | | 65.4 mol % | 190 | | | | | | | |
| | JMR-10M | Degree of | Degree of | | 5 | | | | | 3 |
| | | saponification | polymerization | | | | | | | |
| | | 65.0 mol % | 250 | | | | | | | |
| | JMR-20L | Degree of | Degree of | | | 5 | | | | |
| | | saponification | polymerization | | | | | | | |
| | | 37.1 mol % | 360 | | | | | | | |
| | JMR-20M | Degree of | Degree of | | | | 5 | | | |
| | | saponification | polymerization | | | | | | | |
| | | 64.6 mol % | 360 | | | | | | | |
| | PVA (HP- | Degree of | Degree of | | | | | 5 | | |
| | H205) | saponification | polymerization | | | | | | | |
| | | 87.8 mol % | 500 | | | | | | | |
| | PVA (PVA217) | Degree of | Degree of | | | | | | 5 | |
| | | saponification | polymerization | | | | | | | |
| | | 88.0 mol % | 1700 | | | | | | | |

| | | | | | | | |
|---|---|---|---|---|---|---|---|
| Water | 71 | 71 | 71 | 71 | 71 | 71 | 73 |
| Total (part) | 100 | 100 | 100 | 100 | 100 | 100 | 100 |

Details of the materials shown in Table 4 mean as follows.

BRILLIANT-15: “BRILLIANT-15 (trade name)” (colloidal calcium carbonate powder with average particle diameter of 150 nm) available from Shiraishi Kogyo Kaisha, Ltd.
DEMOL EP: “DEMOL EP (trade name)” (special polycarboxylate type polymer surfactant with solid matter of 25%) available from Kao Corporation.
JPR-8M: “JMR-8M (trade name)” with degree of polymerization of 190 and degree of saponification of 65.4 mol % available from JAPAN VAM & POVAL CO., LTD.
JPR-10M: “JMR-10M (trade name)” with degree of polymerization of 250 and degree of saponification of 65.0 mol % available from JAPAN VAM & POVAL CO., LTD.
JPR-20L: “JMR-20L (trade name)” with degree of polymerization of 360 and degree of saponification of 37.1 mol % available from JAPAN VAM & POVAL CO., LTD.
JPR-20M: “JMR-20M (trade name)” with degree of polymerization of 360 and degree of saponification of 64.6 mol % available from JAPAN VAM & POVAL CO., LTD.
PVA (HP-H205): “HP-H205 (trade name)” with degree of polymerization of 500 and degree of saponification of 87.8 mol % available from KURARAY CO., LTD.
PVA (PVA217): “PVA217 (trade name)” with degree of polymerization of 1700 and degree of saponification of 88.0 mol % available from KURARAY CO., LTD.

### Production Example 2

### Preparation of an Oil Ink

The components shown in Table 5 were premixed in the ratio shown in Table 5, and then the mixture was dispersed in a beads mill (using zirconium beads having a diameter (φ) of 0.5 mm). The resulting dispersion was filtered with a membrane filter (having pores of 3 μm in diameter) to obtain the oil ink 1.

TABLE 5

| Component | | | Ink 1 |
|---|---|---|---|
| Pigment | MA-11 | | 8 |
| Dispersing agent | SOLSPERSE-28000 | | 2 |
| Organic solvent | EXCEPARL M-OL | Methyl oleate | 30 |
| | EXCEPARL IPM | Isopropyl myristate | 30 |
| | NORMAL | Hydrocarbon solvent | 30 |
| | PARAFFIN H | | |

| | |
|---|---|
| Total (part) | 100 |

Details of the materials shown in Table 5 mean as follows.

MA-11: “MA-11 (trade name)” (carbon black) available from Mitsubishi Chemical Corporation.
SOLSPERSE 28000: “SOLSPERSE 28000 (trade name)” (a pigment dispersing agent) available from Lubrizol Japan Ltd.
EXCEPARL M-OL: “EXCEPARL M-OL (trade name)” (methyl oleate) available from Kao Corporation.
EXCEPARL IPM: “EXCEPARL IPM (trade name)” (isopropyl myristate) available from Kao Corporation.
NORMAL PARAFFIN H: “NORMAL PARAFFIN H (trade name)” (hydrocarbon solvent) available from Nippon Oil Corporation.

### Examples II-1 to II-5

### Comparative Examples II-1 to II-3

The oil ink shown in Table 5 was introduced into the ejection route of the inkjet printer “HC5500 (trade name)” manufactured by RISO KAGAKU CORPORATION. Using plain paper “RISO-YOSHI, USUKUCHI (trade name)” manufactured by RISO KAGAKU CORPORATION as printing paper, the pre-treatment solution shown in Table 6 was coated on an entire surface on one side of the printing paper with an automatic bar coater so that a solid matter after drying was about 3.6 g/m². Then, the oil ink was ejected onto the treated surface of the printing paper to print a solid image with parts of 2 to 7 drops in which the ink amount per 1 drop was 6 pL. Printing was carried out under the condition that the resolution was 300×300 dpi. The resulting prints were evaluated in accordance with the following standards. The results are shown in Table 6.

Printing density of prints: The resulting prints were left to stand at 23° C. and 50% R.H. for about 1 day, and then printing density (OD value) of the surface of the solid image (ink amount: 30 pL/dot) was measured with an optical densitometer (RD920; manufactured by Macbeth) and evaluated in accordance with the following standards.

◯: not less than 1.15
Δ: not less than 1.05 and less than 1.15
X: less than 1.05

Ink stain transferred by roller: Printing paper “RISO-YOSHI IJ MATTE (W) (trade name)” available from RISO KAGAKU CORPORATION was overlaid on the solid image of the resulting print immediately after printing (that is, 5 seconds later), and a plastic roller was moved on the paper in a back and forth motion five times. The image of ink transferred to the paper “RISO-YOSHI IJ MATTE (W) (trade name)” was taken by a scanner under the following condition.

### <Condition>

Scanner: “RICOH IMAGIO NEO C455i (trade name)” available from Ricoh Company, Ltd.

### Mode: Grayscale

### Resolution: 600 dpi

### Density: Maximum

File format: JPEG

The resulting image was set at a contrast of 80 on “ADOBE PHOTOSHOP (trade name)” manufactured by ADOBE SYSTEMS INCORPORATED, and the transferred solid image with parts of 2-7 drops in which the ink amount per 1 drop was 6 pL was cut out and stored, and then a value of stain transferred by the roller was obtained by subtracting a histogram value of blank paper “RISO-YOSHI IJ MATTE (W) (trade name)” from a histogram value of brightness obtained with an image analysis software “IMAGE PRO PLUS (trade name)” manufactured by Nippon Roper K.K. Evaluation was made on a condition that a value of ink stain transferred by the roller to non-treated paper “RISO-YOSHI, USUKUCHI (trade name)” manufactured by RISO KAGAKU CORPORATION was 1000.

⊚: a value of ink stain transferred by roller was less than 500
◯: a value of ink stain transferred by roller was not less than 500 and less than 1000
Δ: a value of ink stain transferred by roller was not less than 1000 and less than 10000
X: a value of ink stain transferred by roller was not less than 10000

TABLE 6

| | | | | | | | Comp. | Comp. | Comp. |
|---|---|---|---|---|---|---|---|---|---|
| | | Example | Example | Example | Example | Example | Example | Example | Example |
| | | II-1 | II-2 | II-3 | II-4 | II-5 | II-1 | II-2 | II-3 |
| Pre-treatment | Type | Pre- | Pre- | Pre- | Pre- | Pre- | No pre- | Pre- | Pre- |
| solution | | treatment | treatment | treatment | treatment | treatment | treatment | treatment | treatment |
| | | solution 1 | solution 2 | solution 4 | solution 5 | solution 7 | solution | solution 3 | solution 6 |
| | Degree of | 190 | 250 | 360 | 500 | 250 | — | 360 | 1700 |
| | polymerization | | | | | | | | |
| | Degree of | 65.4 | 65.0 | 64.6 | 87.8 | 65.0 | — | 37.1 | 88.0 |
| | saponification | | | | | | | | |
| | (mol %) | | | | | | | | |
| | Ratio of polyvinyl | 25.0 | 25.0 | 25.0 | 25.0 | 15.0 | — | 25.0 | 25.0 |
| | alcohol (mass % | | | | | | | | |
| | per inorganic | | | | | | | | |
| | particles) | | | | | | | | |
| Evaluation | Printing density | ◯ | ◯ | ◯ | ◯ | ◯ | X | X | X |
| | Ink stain | ◯ | ⊚ | ⊚ | ⊚ | Δ | Δ | X | X |
| | transferred by roll | | | | | | | | |

The followings are found from the results of Table 6.

In Examples II-1 to II-5 in which the pre-treatment solution of the present invention was used, sufficient printing density was obtained, and ink stain transferred by the roller was also prevented. Particularly, in Examples II-1 to II-4, ink stain transferred by the roller was prevented remarkably.

In contrast, in Comparative Example II-1 in which no pre-treatment solution was used was low in printing density. Also, in Comparative Example II-2 in which the pre-treatment solution containing a polyvinyl alcohol with a degree of saponification of less than 60 mol % was used and Comparative Example II-3 in which the pre-treatment solution containing a polyvinyl alcohol with a degree of polymerization exceeding 500 was used, printing density was low, and ink stain transferred by the roller also occurred.

The inkjet printing method and the ink set according to the present invention can be easily practiced by an inkjet printer in which a printing medium is surface-treated with a pre-treatment solution, and then an oil ink is ejected from a nozzle head to print on the treated surface of the printing medium, and thus can be utilized widely in the field of inkjet printing.

1. A printing method using an oil ink, which comprises applying a pre-treatment solution onto a printing medium and then performing printing on the printing medium with an oil ink that comprises at least a coloring material and a solvent, in which said pre-treatment solution is selected from the pre-treatment solutions shown in the following (I), (II) and (III):
(I): a pre-treatment solution which comprises at least inorganic particles with an average particle diameter of not less than 1 μm and not more than 20 μm and a solvent, in which the difference in solubility parameter (SP value) between the solvent of the pre-treatment solution and the solvent of the oil ink is not less than 1.0 (cal/cm³)^{1/2};
(II): a pre-treatment solution which comprises at least inorganic particles with an average particle diameter of not less than 0.1 μm and less than 1 μm and a solvent, in which the difference in solubility parameter (SP value) between the solvent of the pre-treatment solution and the solvent of the oil ink is not less than 2.0 (cal/cm³)^{1/2}; and
(III): a pre-treatment solution which comprises at least inorganic particles, a polyvinyl alcohol with a degree of polymerization of not more than 500 and a degree of saponification of not less than 60 mol %, and water.

2. The printing method according to claim 1, wherein the pre-treatment solution shown in the above (I) is used as the pre-treatment solution, and the oil ink is ejected onto the printing medium by an inkjet method to perform printing, in which said inorganic particles have a liquid absorbency (A) in a range of 0.2-1.4 as obtained in accordance with the following equation (1):
A=B/C (1)
wherein
A: liquid absorbency of inorganic particles;
B: oil absorption of inorganic particles (ml/100 g); and
C: specific surface area of inorganic particles (m²/g).

3. The printing method according to claim 2, wherein said pre-treatment solution is applied in an amount of 0.3-2.5 g/m² as an amount of inorganic particles.

4. The printing method according to claim 1, wherein the pre-treatment solution shown in the above (II) is used as the pre-treatment solution, and the oil ink is ejected onto the printing medium by an inkjet method to perform printing, in which said inorganic particles are silica or calcium carbonate.

5. The printing method according to claim 1, wherein the pre-treatment solution shown in the above (III) is used as the pre-treatment solution, and the oil ink is ejected onto the printing medium by an inkjet method to perform printing, in which said inorganic particles are at least one selected from the group consisting of calcium carbonate, silica and colloidal silica.

6. An ink set useful for applying a pre-treatment solution onto a printing medium and then performing printing on the printing medium with an oil ink, which comprises an oil ink comprising at least a coloring material and a solvent, and a pre-treatment solution selected from the pre-treatment solutions shown in the following (I), (II) and (III):
(I): a pre-treatment solution which comprises at least inorganic particles with an average particle diameter of not less than 1 μm and not more than 20 μm and a solvent, in which the difference in solubility parameter (SP value) between the solvent of the pre-treatment solution and the solvent of the oil ink is not less than 1.0 (cal/cm³)^{1/2};
(II): a pre-treatment solution which comprises at least inorganic particles with an average particle diameter of not less than 0.1 μm and less than 1 μm and a solvent, in which the difference in solubility parameter (SP value) between the solvent of the pre-treatment solution and the solvent of the oil ink is not less than 2.0 (cal/cm³)^{1/2}; and
(III) a pre-treatment solution which comprises at least inorganic particles, a polyvinyl alcohol with a degree of polymerization of not more than 500 and a degree of saponification of not less than 60 mol %, and water.

7. The ink set according to claim 6, wherein the pre-treatment solution shown in the above (I) is used as the pre-treatment solution, and the oil ink is ejected onto the printing medium by an inkjet method to perform printing, in which said inorganic particles have a liquid absorbency (A) in a range of 0.2-1.4 as obtained in accordance with the following equation (1):
A=B/C (1)
wherein
A: liquid absorbency of inorganic particles;
B: oil absorption of inorganic particles (ml/100 g); and
C: specific surface area of inorganic particles (m²/g).

8. The ink set according to claim 6, wherein the pre-treatment solution shown in the above (II) is used as the pre-treatment solution, and the oil ink is ejected onto the printing medium by an inkjet method to perform printing in which said inorganic particles are silica or calcium carbonate.

9. The ink set according to claim 6, wherein the pre-treatment solution shown in the above (III) is used as the pre-treatment solution, and the oil ink is ejected onto the printing medium by an inkjet method to perform printing, in which said inorganic particles are at least one selected from the group consisting of calcium carbonate, silica and colloidal silica.
